(19) United States
(12) Patent Application Publication
(10) Pub. No.: US 2026/0055652 A1
(43) Pub. Date: Feb. 26, 2026

(54) HOME APPLIANCE AND METHOD OF CONTROLLING THE SAME

(71) Applicant: SAMSUNG ELECTRONICS CO., LTD., Suwon-si (KR)

(72) Inventors: Chanyoung PARK, Suwon-si (KR); Duckjin SUNG, Suwon-si (KR); Taein EOM, Suwon-si (KR); Hyunuk PARK, Suwon-si (KR)

(73) Assignee: SAMSUNG ELECTRONICS CO., LTD., Suwon-si (KR)

(21) Appl. No.: 19/312,539

(22) Filed: Aug. 28, 2025

Related U.S. Application Data
(63) Continuation of application No. PCT/KR2025/012692, filed on Aug. 21, 2025.

(30) Foreign Application Priority Data
Aug. 26, 2024 (KR) 10-2024-0114514
Mar. 6, 2025 (KR) 10-2025-0029310
Apr. 29, 2025 (KR) 10-2025-0056561

(51) Int. Cl. E05F 15/619; E05F 15/63; F25D 23/02

(52) U.S. Cl. CPC E05F 15/619; E05F 15/63; F25D 23/028; E05Y 2900/31

(57) ABSTRACT

A home appliance according to an embodiment of the present disclosure includes a main body having a receiving space, a door configured to open or close the receiving space, and a door opening/closing device to open or close the door. The door opening/closing device includes a push portion including a push rod to open the door and an opening gear train connected to the push rod, a linkage portion including a link to close the door and a closing gear train connected to the link, a drive portion including a drive motor and a sun gear and a clutch portion including a planetary gear, movable between an open position connected to the opening gear train and a closed position connected to a closing gear train. The clutch portion is configured to transmit a driving force of the drive motor to the push portion or the linkage portion.

### CROSS-REFERENCE TO RELATED APPLICATION

This application is a continuation application is a continuation application, under 35 U.S.C. § 111 (a), of international application No. PCT/KR2025/012692, filed Aug. 21, 2025, which claims priority under 35 U. S. C. § 119 to Korean Patent Application No. 10-2024-0114514, filed Aug. 26, 2024, Korean Patent Application No. 10-2025-0029310, filed Mar. 6, 2025, and Korean Patent Application No. 10-2025-0056561, filed Apr. 29, 2025, the disclosures of which are incorporated herein by reference in their entireties.

### TECHNICAL FIELD

The disclosure relates to a home appliance and a method of controlling the same, and more particularly to a home appliance having a door opening/closing device for opening and closing a door, and a method of controlling the same.

### BACKGROUND ART

In general, home appliances are electronic products used primarily in the home, and include refrigerators, dishwashers, ovens, and the like. These home appliances include a main body with a receiving space formed therein to store items for processing the items, and a door for opening and closing the receiving space.

A home appliance may be provided with various convenience devices to enhance user convenience. For example, a door opening/closing device capable of automatically opening or closing a door via a driving force generated by a drive source may be provided.

### DISCLOSURE

### Technical Problem

An embodiment of the present disclosure provides a home appliance having a door opening/closing device capable of opening or closing a door via a single drive source.

An embodiment of the present disclosure provides a home appliance having a door opening/closing device in which an opening operation and a closing operation of a door may be performed smoothly and efficiently.

An embodiment of the present disclosure provides a home appliance capable of automatic opening/closing of a door via a driving force generated from a drive source and manual opening/closing of the door by a user's operation.

Technical tasks to be achieved in this document are not limited to the technical tasks mentioned above, and other technical tasks not mentioned will be clearly understood by those skilled in the art from the description below.

### Technical Solution

A home appliance according to an embodiment of the present disclosure includes a main body having a receiving space, a door configured to open or close to respectively open or close the receiving space, and a door opening/closing device on the main body configured to open or close the door, wherein the door opening/closing device includes a push portion including a push rod configured to push the door so as to open the door and an opening gear train connected to the push rod and configured to move the push rod, a linkage portion including a link connected to the door and configured so as to close the door and a closing gear train connected to the link and configured to move the link, a drive portion including a drive motor and a sun gear connected to the drive motor, the drive motor configured to generate a driving force to rotate the sun gear, and a clutch portion including a planetary gear, the planetary gear connected to the sun gear, configured to rotate with the sun gear, and movable between an open position where the planetary gear is connected to the opening gear train and a closed position were the planetary gear is connected to the closing gear train, so as to transmit the driving force of the drive motor to the push portion based on the planetary gear being in the open position or the linkage portion based on the planetary gear being in the closed position.

The home appliance may further include an input interface configured to receive an open command and a close command, and a controller configured to control the drive motor to open the door based on the open command being received through the input interface, and control the drive motor to close the door based on the close command being received through the input interface.

The controller may drive the drive motor in a forward direction until the controller recognizes that the door has been opened to a set angle based on the open command being received through the input interface, and drive the drive motor in a reverse direction until the controller recognizes that the planetary gear has reached a neutral position based on recognizing that the door has been opened to the set angle.

The controller may drive the drive motor in a reverse direction until the controller recognizes that the door has been closed based on the close command being received through the input interface, and drive the drive motor in a forward direction until the controller recognizes that the planetary gear has reached a neutral position based on recognizing that the door has been closed.

The planetary gear may be configured to be meshed with the sun gear.

Based on the planetary gear being positioned between the open position and the closed position, the planetary gear may be capable of revolving around the sun gear between the open position and the closed position in conjunction with rotation of the sun gear.

Based on the planetary gear being in the open position, the planetary gear may be capable of rotating on its axis in conjunction with rotation of the sun gear, and an opening gear of the opening gear train rotates in conjunction with the rotation on its axis of the planetary gear, and based on the planetary gear being in the closed position, the planetary gear may be capable of rotating on its axis in conjunction with rotation of the sun gear, and a closing gear of the closing gear train rotates in conjunction with the rotation on its axis of the planetary gear.

The drive portion may include a sun gear pin configured to pass through a central portion of the sun gear to guide rotation of the sun gear.

The clutch portion may include a carrier plate rotatably provided about the sun gear pin, and the planetary gear may be mountable on the carrier plate.

The clutch portion may include a friction member configured to generate a frictional force between the planetary gear and the carrier plate to allow the planetary gear to revolve around the sun gear in conjunction with the rotation of the sun gear.

The clutch portion may include a planetary gear pin provided on the carrier plate to pass through a central portion of the planetary gear to guide rotation on its axis of the planetary gear.

The push rod may be capable of linear movement between a maximum advanced position and a maximum retracted position.

The push portion may include an elastic member configured to elastically bias the push rod to the maximum retracted position.

The home appliance may further include a hinge connecting the main body and the door and configured to rotatably support the door relative to the main body, a cam coupled to the hinge and having a guide surface, and a lever device coupled to the door and having a lever configured to contact the cam when the door is opened or closed.

The guide surface may include a first contact surface configured to allow the lever to apply a force in a direction of closing the door when the lever is contacted, a second contact surface configured to allow the lever to transmit a force in a direction of opening the door when the lever is contacted, and a inflection point provided between the first contact surface and the second contact surface; and the lever may contact the second contact surface past the inflection point when the push rod is in the maximum advanced position.

A home appliance according to an embodiment of the present disclosure includes a main body having a receiving space, a door configured to open or close the receiving space, and a door opening/closing device provided on the main body to open or close the door, wherein the door opening/closing device includes a drive motor rotatable in a forward or reverse direction; a sun gear rotatable by a driving force of the drive motor; an opening gear train configured to open the door; a closing gear train configured to close the door; and a planetary gear meshed with the sun gear to transmit a driving force of the drive motor to the opening gear train or to the closing gear train, the planetary gear being configured to revolve or rotate depending on whether the planetary gear is connected to the opening gear train or the closing gear train.

When the planetary gear is not connected to the opening gear train and the closing gear train, the planetary gear may be capable of revolving around the sun gear in conjunction with rotation of the sun gear.

When the planetary gear is connected to the opening gear train, the planetary gear may rotate in conjunction with rotation of the sun gear, and an opening gear of the opening gear train may rotate in conjunction with rotation of the planetary gear.

When the planetary gear is connected to the closing gear train, the planetary gear may rotate in coordination with rotation of the sun gear, and a closing gear of the closing gear train may rotate in conjunction with rotation of the planetary gear.

The door opening/closing device may include a push rod movable for opening the door in conjunction with rotation of the opening gear, and a link movable for closing the door in conjunction with rotation of the closing gear.

### Advantageous Effects

According to various embodiments of the present disclosure, the door opening/closing device may open or close the door using a single drive source.

According to various embodiments of the present disclosure, the door opening/closing device may smoothly and efficiently perform the door opening operation and closing operations.

According to various embodiments of the present disclosure, the door may be automatically opened or closed through the driving force generated by the drive source and manually opened or closed by a user's operation.

According to various embodiments of the present disclosure, noise generation may be reduced during the operation in which the door is automatically closed by the door opening/closing device.

The effects that can be obtained from the present disclosure are not limited to those mentioned above, and other effects not mentioned will be apparent to those of skilled in the art from the following description.

### DESCRIPTION OF DRAWINGS

FIG. 1 is a view illustrating a refrigerator according to an embodiment of the present disclosure.

FIG. 2 is a view illustrating an upper surface of the refrigerator according to an embodiment of the present disclosure.

FIG. 3 is a view illustrating a door opening/closing device according to an embodiment of the present disclosure.

FIG. 4 is an exploded view illustrating a portion of a linkage portion of the door opening/closing device according to an embodiment of the present disclosure.

FIG. 5 is a plan view illustrating an internal structure of the door opening/closing device according to an embodiment of the present disclosure.

FIG. 6 is a perspective view illustrating the internal structure of the door opening/closing device according to an embodiment of the present disclosure.

FIG. 7 is a view illustrating a sun gear and a clutch portion separated from the door opening/closing device of FIG. 6.

FIG. 8 is a perspective view illustrating a bottom surface of the sun gear according to an embodiment of the present disclosure.

FIG. 9 is an exploded perspective view illustrating the clutch portion according to an embodiment of the present disclosure.

FIG. 10 is a view illustrating a position sensor according to an embodiment of the present disclosure.

FIG. 11 is a cross-sectional view illustrating the sun gear and the clutch portion according to an embodiment of the present disclosure.

FIG. 12 is a view illustrating a push rod and an elastic member separated from the door opening/closing device of FIG. 6.

FIG. 13 is a cross-sectional view illustrating the push rod and the elastic member according to an embodiment of the present disclosure.

FIG. 14 is a block diagram illustrating a control configuration of the refrigerator according to an embodiment of the present disclosure.

FIG. 15 is a view illustrating an initial state of the door opening/closing device.

FIG. 16 is a view illustrating a state in which a planetary gear has moved to an open position as the planetary gear revolves in conjunction with rotation of a sun gear.

FIG. 17 is a view illustrating a state in which a push rod has advanced to a maximum advanced position as the planetary gear rotates on its axis in conjunction with rotation of the sun gear.

FIG. 18 is a view illustrating a state in which the push rod has returned to a maximum retracted position by an elastic force of an elastic member.

FIG. 19 is a view illustrating a state in which the planetary gear has moved to a closed position as the planetary gear revolves around the sun gear in conjunction with rotation of the sun gear.

FIG. 20 is a view illustrating a state in which a link is folded to a folded position as the planetary gear rotates on its axis in conjunction with rotation of the sun gear.

FIG. 21 is a view illustrating a cam and a lever device in a door closed state of FIGS. 15 and 16.

FIG. 22 is a view illustrating the cam and the lever device when the push rod of FIG. 17 is in the maximum advanced position.

FIG. 23 is a view illustrating a control flow when an open command is received according to an embodiment of the present disclosure.

FIG. 24 is a view illustrating a control flow when an open command is received according to an embodiment of the present disclosure.

FIG. 25 is a view illustrating a control flow when an open command is received according to an embodiment of the present disclosure.

FIG. 26 is a view illustrating a control flow when a close command is received according to an embodiment of the present disclosure.

FIG. 27 is a view illustrating a control flow when a close command is received according to an embodiment of the present disclosure.

### MODES OF THE INVENTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the term “and/or” includes any and all combinations of one or more of associated listed items.

Terms such as “1st”, “2nd”, “primary”, or “secondary” may be used simply to distinguish a component from other components, without limiting the component in other aspects (e.g., importance or order).

Further, as used in the disclosure, the terms “front”, “rear”, “top”, “bottom”, “side”, “left”, “right”, “upper”, “lower”, and the like are defined with reference to the drawings, and are not intended to limit the shape and position of each component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” another component, it can be directly on the other component or intervening components may also be present.

A refrigerator according to an embodiment of the disclosure may include a main body.

The main body may include an insulation. The insulation may insulate inside of a storage compartment from outside of the storage compartment to maintain inside temperature of the storage compartment at appropriate temperature without being influenced by an external environment of the storage compartment. According to an embodiment of the disclosure, the insulation may include a foaming insulation such as a polyurethane foam. According to an embodiment of the disclosure, the insulation may include a vacuum insulation in addition to a foaming insulation, or may be configured only with a vacuum insulation instead of a forming insulation.

The storage compartment may store a variety of items, such as foods, medicines, cosmetics, and the like, and the storage compartment may be formed to be open on at least one side for storing or removing items.

The refrigerator may include one or more storage compartments. In a case in which two or more storage compartments are formed in the refrigerator, the respective storage compartments may have different purposes of use, and may be maintained at different temperature. To this end, the storage compartments may be partitioned by a partition wall including an insulation.

The storage compartment may be maintained within an appropriate temperature range according to a purpose of use, and include a “refrigerating compartment”, a “freezing compartment”, and a “temperature conversion compartment” according to purposes of use and/or temperature ranges. The refrigerating compartment may be maintained at appropriate temperature to keep food refrigerating, and the freezing compartment may be maintained at appropriate temperature to keep food frozen. The “refrigerating” may be keeping food cold without freezing the food, and for example, the refrigerating compartment may be maintained within a range of 0 degrees Celsius to 7 degrees Celsius. The “freezing” may be freezing food or keeping food frozen, and for example, the freezing compartment may be maintained within a range of −20 degrees Celsius to −1 degrees Celsius. The temperature conversion compartment may be used as any one of a refrigerating compartment or a freezing compartment according to or regardless of a user's selection.

The storage compartment may also be called various other terms, such as “vegetable compartment (also referred to as room)”, “freshness compartment”, “cooling compartment”, and “ice-making compartment”, in addition to “refrigerating compartment”, “freezing compartment”, and “temperature conversion compartment”, and the terms, such as “refrigerating compartment”, “freezing compartment”, “temperature conversion compartment”, etc., as used below need to be understood to represent storage compartments having the corresponding purposes of use and the corresponding temperature ranges.

The refrigerator according to an embodiment of the disclosure may include at least one door configured to open or close the open side of the storage compartment. The respective doors may be provided to open and close one or more storage compartments, or a single door may be provided to open and close a plurality of storage compartments. The door may be rotatably or slidably mounted on the front of the main body.

The door may seal the storage compartment in a closed state. The door may include an insulation, like the main body, to insulate the storage compartment in the closed state.

According to an embodiment, the door may include an outer door plate forming the front surface of the door, an inner door plate forming the rear surface of the door and facing the storage compartment, an upper cap, a lower cap, and a door insulation provided therein.

A gasket may be provided on the edge of the inner door plate to seal the storage compartment by coming into close contact with the front surface of the main body when the door is closed. The inner door plate may include a dyke that protrudes rearward to allow a door basket for storing items to be fitted.

According to an embodiment, the door may include a door body and a front panel that is detachably coupled to the front of the door body and forms the front surface of the door. The door body may include an outer door plate that forms the front surface of the door body, an inner door plate that forms the rear surface of the door body and faces the storage compartment, an upper cap, a lower cap, and a door insulator provided therein.

The refrigerator may be classified as French Door Type, Side-by-side Type, Bottom Mounted Freezer (BMF), Top Mounted Freezer (TMF), or One Door Refrigerator depending on the arrangement of the doors and the storage compartments.

The refrigerator according to an embodiment of the disclosure may include a cold air supply device for supplying cold air to the storage compartment.

The cold air supply device may include a machine, an apparatus, an electronic device, and/or a combination system thereof, capable of generating cold air and guiding the cold air to cool the storage compartment.

According to an embodiment of the disclosure, the cold air supply device may generate cold air through a cooling cycle including compression, condensation, expansion, and evaporation processes of refrigerants. To this end, the cold air supply device may include a cooling cycle device having a compressor, a condenser, an expander, and an evaporator to drive the cooling cycle. According to an embodiment of the disclosure, the cold air supply device may include a semiconductor such as a thermoelectric element. The thermoelectric element may cool the storage compartment by heating and cooling actions through the Peltier effect.

The refrigerator according to an embodiment of the disclosure may include a machine compartment where at least some components belonging to the cold air supply device are installed.

The machine compartment may be partitioned and insulated from the storage compartment to prevent heat generated from the components installed in the machine compartment from being transferred to the storage compartment. To dissipate heat from the components installed inside the machine compartment, the machine compartment may communicate with outside of the main body.

The refrigerator according to an embodiment of the disclosure may include a dispenser provided on the door to provide water and/or ice. The dispenser may be provided on the door to allow access by the user without opening the door.

The refrigerator according to an embodiment of the disclosure may include an ice-making device that produces ice. The ice-making device may include an ice-making tray that stores water, an ice-moving device that separates ice from the ice-making tray, and an ice-bucket that stores ice generated in the ice-making tray.

The refrigerator according to an embodiment of the disclosure may include a controller for controlling the refrigerator.

The controller may include a memory for storing and/or memorizing data and/or programs for controlling the refrigerator, and a processor for outputting control signals for controlling the cold air supply device, etc. according to the programs and/or data memorized in the memory.

The memory may store or record various information, data, commands, programs, and the like necessary for operations of the refrigerator. The memory may store temporary data generated while generating control signals for controlling components included in the refrigerator. The memory may include at least one of volatile memory or non-volatile memory, or a combination thereof.

The processor may control the overall operation of the refrigerator. The processor may control the components of the refrigerator by executing programs stored in memory. The processor may include a separate neural processing unit (NPU) that performs an operation of an artificial intelligence (AI) model. In addition, the processor may include a central processing unit (CPU), a graphics processor (GPU), and the like. The processor may generate a control signal to control the operation of the cold air supply device. For example, the processor may receive temperature information of the storage compartment from a temperature sensor, and generate a cooling control signal for controlling an operation of the cold air supply device based on the temperature information of the storage compartment.

Furthermore, the processor may process a user input of a user interface and control an operation of the user interface according to the programs and/or data memorized/stored in the memory. The user interface may be provided using an input interface and an output interface. The processor may receive the user input from the user interface. In addition, the processor may transmit a display control signal and image data for displaying an image on the user interface to the user interface in response to the user input.

The processor and memory may be provided integrally or may be provided separately. The processor may include one or more processors. For example, the processor may include a main processor and at least one sub-processor. The memory may include one or more memories.

The refrigerator according to an embodiment of the disclosure may include a processor and a memory for controlling all the components included in the refrigerator, and may include a plurality of processors and a plurality of memories for individually controlling the components of the refrigerator. For example, the refrigerator may include a processor and a memory for controlling the operation of the cold air supply device according to an output of the temperature sensor. In addition, the refrigerator may be separately equipped with a processor and a memory for controlling the operation of the user interface according to the user input.

A communication module may communicate with external devices, such as servers, mobile devices, and other home appliances via a nearby access point (AP). The AP may connect a local area network (LAN) to which a refrigerator or a user device is connected to a wide area network (WAN) to which a server is connected. The refrigerator or the user device may be connected to the server via the WAN.

The input interface may include keys, a touch screen, a microphone, and the like. The input interface may receive the user input and pass the received user input to the processor.

The output interface may include a display, a speaker, and the like. The output interface may output various notifications, messages, information, and the like generated by the processor.

Hereinafter, various embodiments according to the disclosure will be described in detail with reference to the accompanying drawings.

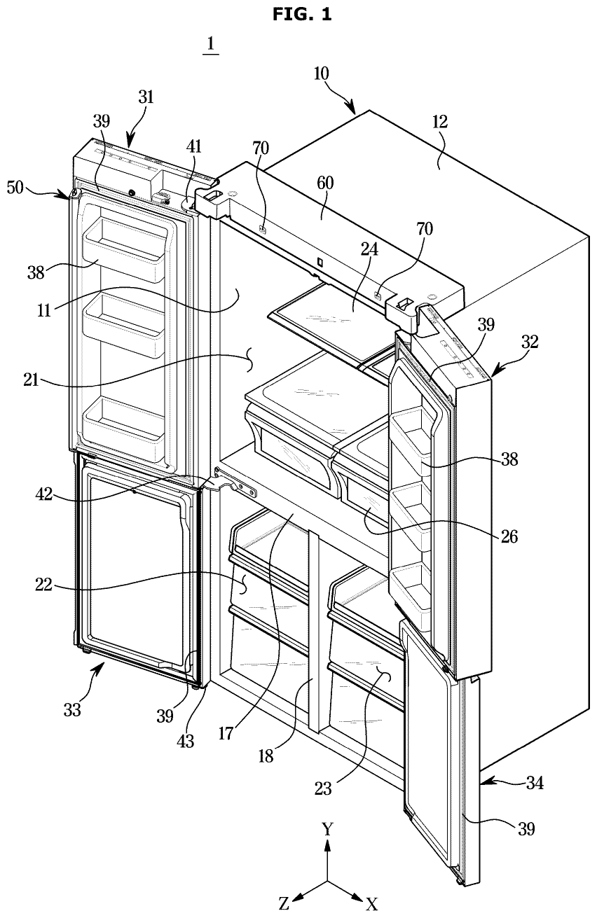

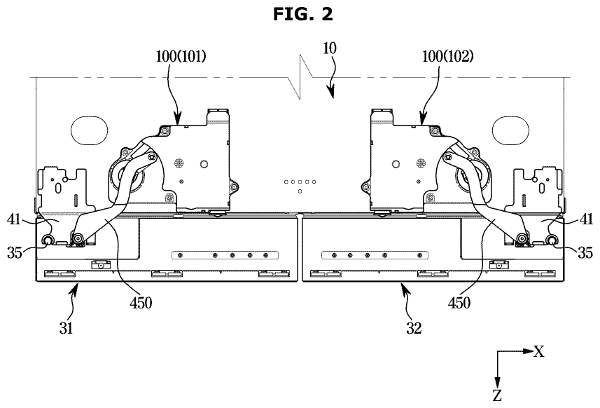

FIG. 1 is a view illustrating a refrigerator according to an embodiment of the present disclosure. FIG. 2 is a view illustrating an upper surface of the refrigerator according to an embodiment of the present disclosure.

In FIGS. 1 and 2, an X direction, a Y direction, and a Z direction may refer to a left-to-right direction, an up-and-down direction, and a front-to-back direction of the refrigerator 1, respectively.

A refrigerator 1 may include a main body 10, storage compartments 21, 22 and 23 formed inside the main body 10, and doors 31, 32, 33 and 34 configured to open or close the storage compartments 21, 22 and 23.

The main body 10 may include an inner case 11, an outer case 12 coupled to an outer side of the inner case 11, and an insulation provided between the inner case 11 and the outer case 12. The inner case 11 may form the storage compartments 21, 22 and 23, and the outer case 12 may form an exterior of the main body 10.

The storage compartments 21, 22 and 23 may be referred to as receiving spaces. The storage compartments 21, 22 and 23 may store items in a refrigerated or frozen state. The storage compartments 21, 22 and 23 may be formed with an open front side to allow items to be placed in or removed. The storage compartments 21, 22 and 23 may be provided with shelves 24 for supporting items or containers 26 for receiving items.

The main body 10 may include a horizontal partition 17 that divides the storage compartments 21, 22 and 23 into an upper first storage compartment 21 and lower storage compartments 22 and 23, and a vertical partition 18 that divides the lower storage compartments 22 and 23 into a second storage compartment 22 and a third storage compartment 23. The first storage compartment 21 may be a refrigerating compartment, the second storage compartment 22 may be a freezing compartment, and the third storage compartment 23 may be a variable temperature compartment.

The doors 31, 32, 33 and 34 may open or close the storage compartments 21, 22 and 23. A first door 31 and a second door 32 may open or close the first storage compartment 21, a third door 33 may open or close the second storage compartment 22, and a fourth door 34 may open or close the third storage compartment 23. The doors 31, 32, 33 and 34 may be rotatably coupled to the main body 10.

The doors 31, 32, 33 and 34 may be rotatably coupled to the main body 10 by hinges 41, 42, and 43, respectively. The first door 31 and the second door 32 may be rotatably provided on the main body 10 by an upper hinge 41 provided on an upper portion of the main body 10 and a middle hinge 42 provided in a middle of the main body 10, respectively. The third door 33 and the fourth door 34 may be rotatably provided by the middle hinge 42 provided in the middle of the main body 10 and a lower hinge 43 provided on a lower portion of the main body 10, respectively.

The doors 31, 32, 33 and 34 may rotate about a door rotation axis 35.

One of the first door 31 and the second door 32 may be provided with a rotation bar 50 for covering a gap formed between the first door 31 and the second door 32 when the first door 31 and the second door 32 are closed. The rotation bar 50 may be rotatably provided on one of the first door 31 and the second door 32.

Each of the doors 31, 32, 33 and 34 may include a gasket 39. The gasket 39 may be provided on a rear surface of each of the doors 31, 32, 33 and 34. The gasket 39 may be in close contact with a front surface of the main body 10 when each of the doors 31, 32, 33 and 34 is closed. Each of the doors 31, 32, 33 and 34 may include a dyke protruding rearwardly. A door shelf 38 capable of storing items may be mounted on the dyke.

While the number and arrangement of the storage compartments and the number and arrangement of the doors have been described above, there is no limitation on the number and arrangement of the storage compartments and the number and arrangement of the doors of the refrigerator according to an embodiment of the present disclosure. For example, the refrigerator may include a plurality of storage compartments arranged in a left-to-right direction or may include only one storage compartment.

The refrigerator 1 may include a top cover 60 coupled to a front portion of an upper surface of the main body 10 to cover the upper hinge 41. The refrigerator 1 may include a door opening/closing device 100 that automatically opens or closes a door through a driving force generated by a drive source. The door opening/closing device 100 may be coupled to the front portion of the upper surface of the main body 10 and may be covered by the top cover 60. As a result, the door opening/closing device 100 may not be exposed to an outside.

The door opening/closing devices 100 may be provided in a plurality. For example, the door opening/closing device 100 may include a first door opening/closing device 101 for opening/closing the first door 31 and a second door opening/closing device 102 for opening/closing the second door 32.

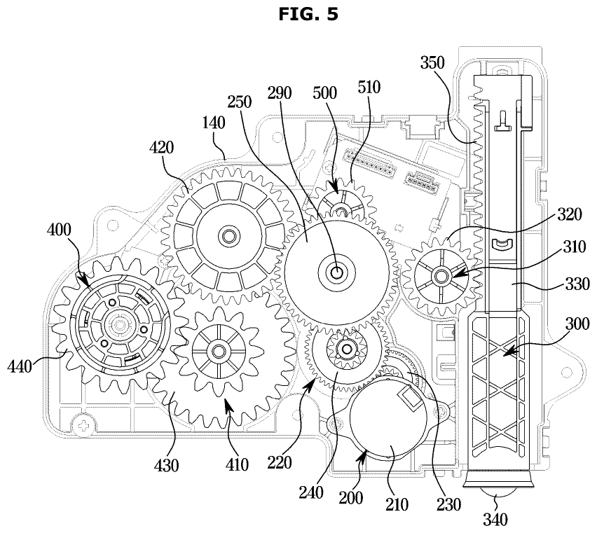

The door opening/closing device 100 may include a push rod 330 (see FIG. 5) that moves forward and backward to open the door. A through-hole 70 may be formed in a front surface of the top cover 60 to allow the push rod 330 of the door opening/closing device 100 to pass therethrough. The through-holes 70 may be provided in a plurality to correspond to the number of push rods 330.

The door opening/closing device 100 may include a link 450 connected to a door to close the door.

A specific configuration of the door opening/closing device 100 will be described later below.

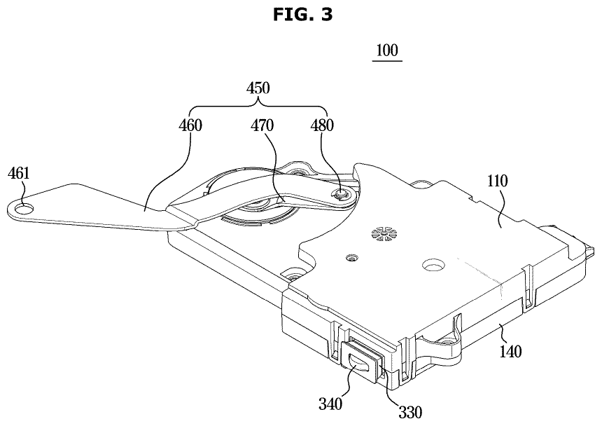

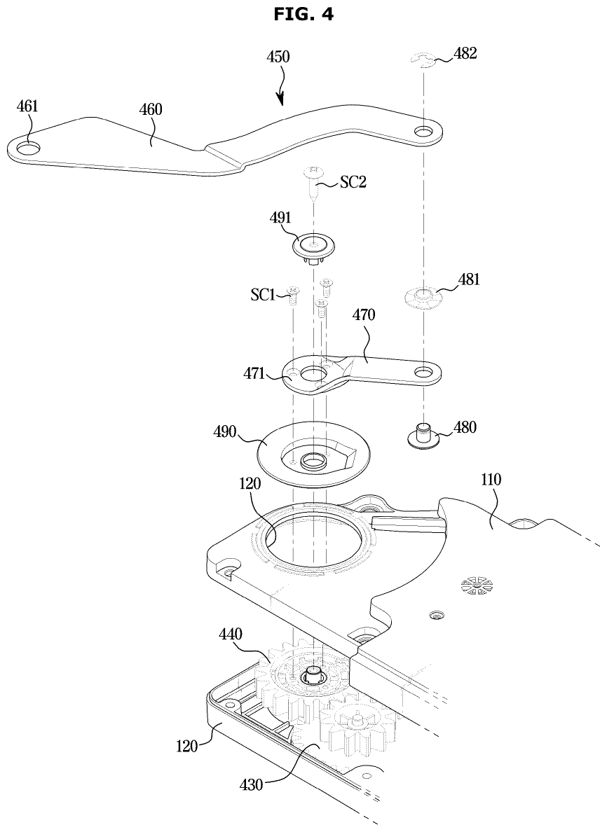

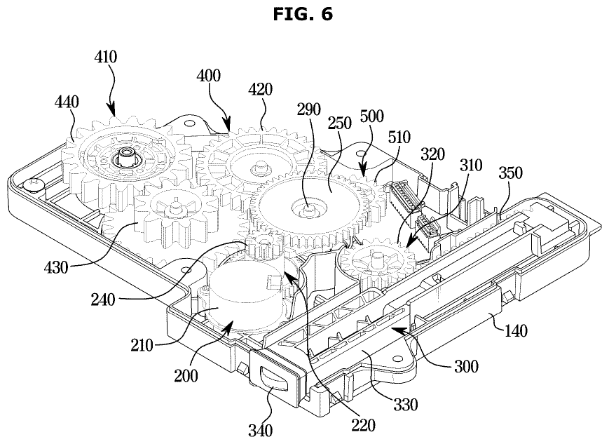

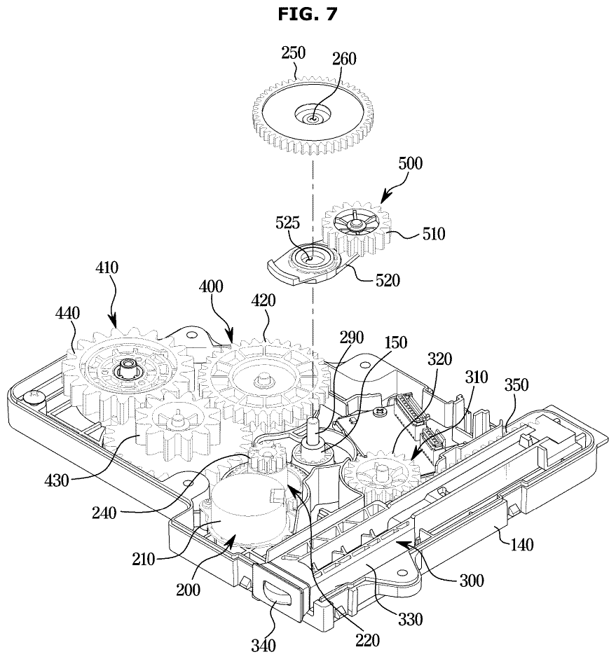

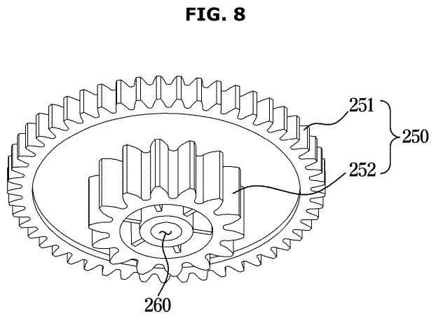

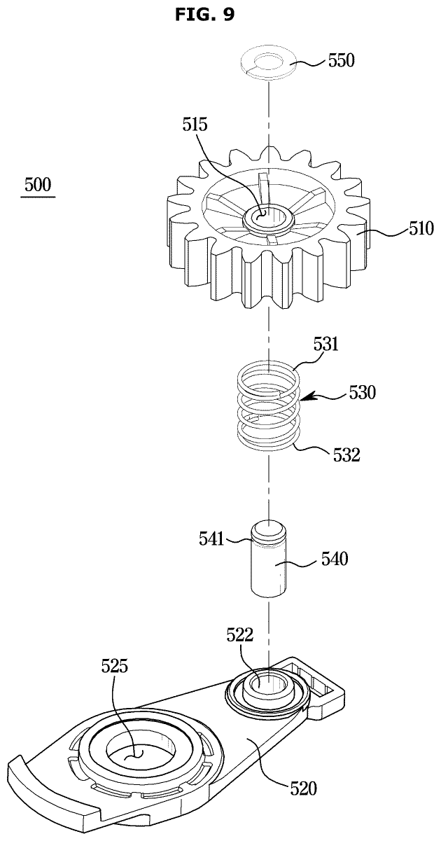

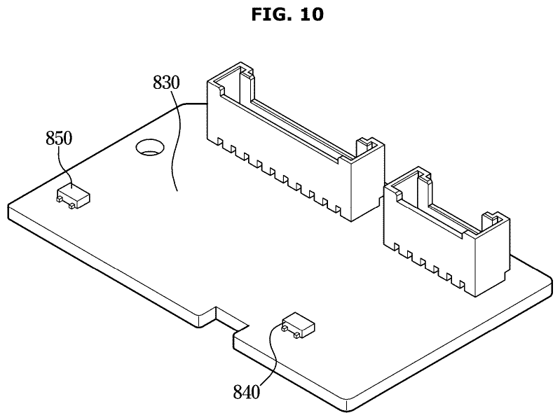

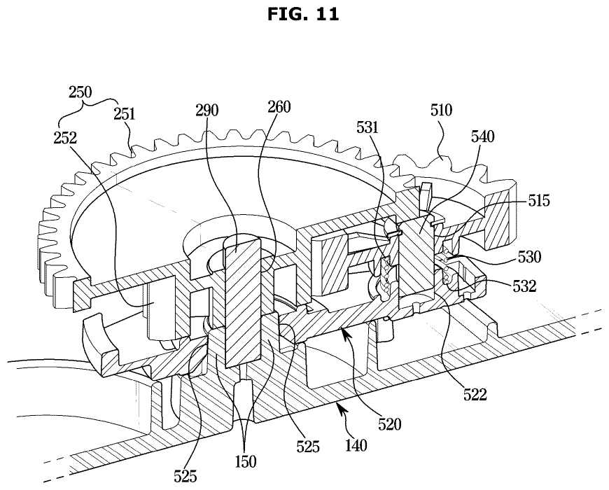

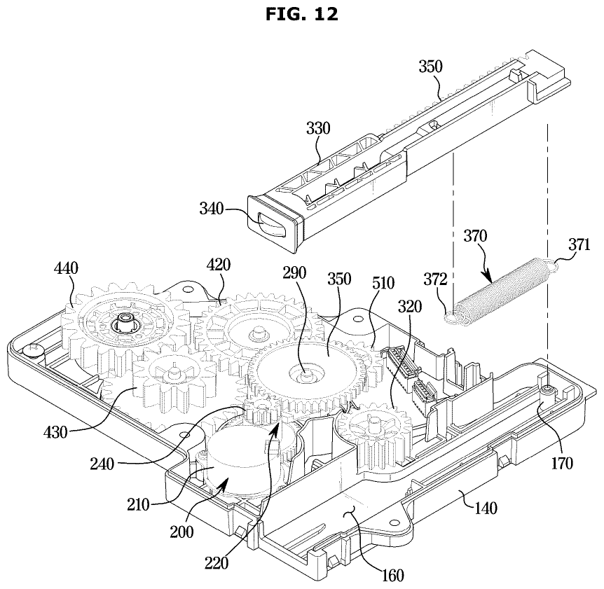

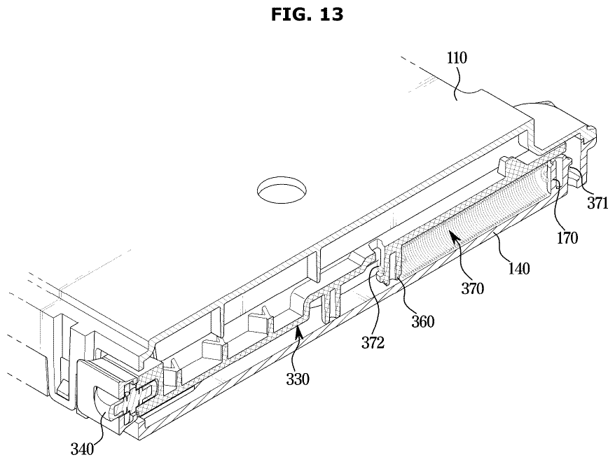

FIG. 3 is a view illustrating the door opening/closing device according to an embodiment of the present disclosure. FIG. 4 is an exploded view illustrating a portion of a linkage portion of the door opening/closing device according to an embodiment of the present disclosure. FIG. 5 is a plan view illustrating an internal structure of the door opening/closing device according to an embodiment of the present disclosure. FIG. 6 is a perspective view illustrating the internal structure of the door opening/closing device according to an embodiment of the present disclosure. FIG. 7 is a view illustrating a sun gear and a clutch portion separated from the door opening/closing device of FIG. 6. FIG. 8 is a perspective view illustrating a bottom surface of the sun gear according to an embodiment of the present disclosure. FIG. 9 is an exploded perspective view illustrating the clutch portion according to an embodiment of the present disclosure. FIG. 10 is a view illustrating a position sensor according to an embodiment of the present disclosure. FIG. 11 is a cross-sectional view illustrating the sun gear and the clutch portion according to an embodiment of the present disclosure. FIG. 12 is a view illustrating a push rod and an elastic member separated from the door opening/closing device of FIG. 6. FIG. 13 is a cross-sectional view illustrating the push rod and the elastic member according to an embodiment of the present disclosure.

The door opening/closing device 100 according to an embodiment of the present disclosure will be described with reference to FIGS. 3 to 13. Since the configurations of the door opening/closing devices on the left and right sides in the drawings correspond to each other, the configuration of the door opening/closing device on the left side will be described, and the description of the configuration of the door opening/closing device on the right side will be omitted.

The door opening/closing device 100 may be configured to automatically open the door 31 or automatically close the door 31 through a driving force generated by a drive source.

The door opening/closing device 100 may include housings 110 and 140, a drive portion 200 for generating a driving force, a push portion 300 for opening the door 31, a linkage portion 400 for closing the door 31, and a clutch portion 500 for transmitting power generated by the drive portion 200 to the push portion 300 or the linkage portion 400.

The housings 110 and 140 may include an upper housing 110 and a lower housing 140 coupled to a lower portion of the upper housing 110. Various gears of the door opening/closing device 100 may be accommodated inside the housings 110 and 140.

The drive portion 200 may include a drive motor 210 as a drive source. The drive motor 210 may convert electrical energy into mechanical rotational force. The drive motor 210 may be driven in both forward and reverse directions.

The drive portion 200 may include a drive gear train 220 for transmitting a driving force generated by the drive motor 210. The drive gear train 220 may include at least one drive gear. In an example, the drive gear train 220 may include a first drive gear 230 meshed with a motor shaft of the drive motor 210, and a second drive gear 240 meshed with the first drive gear 230.

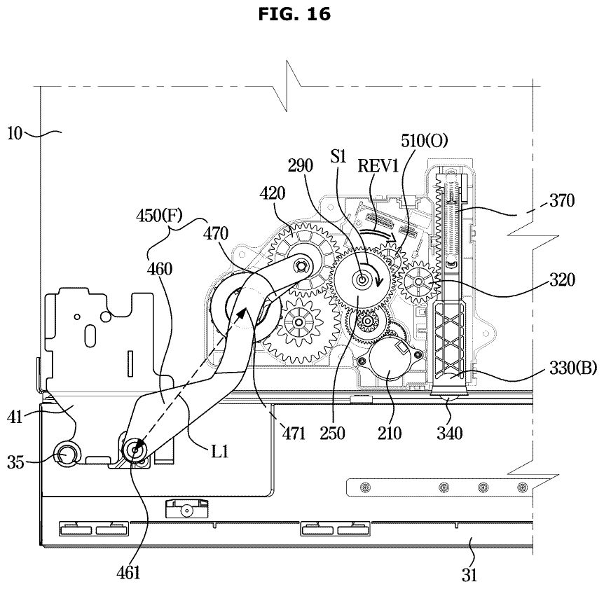

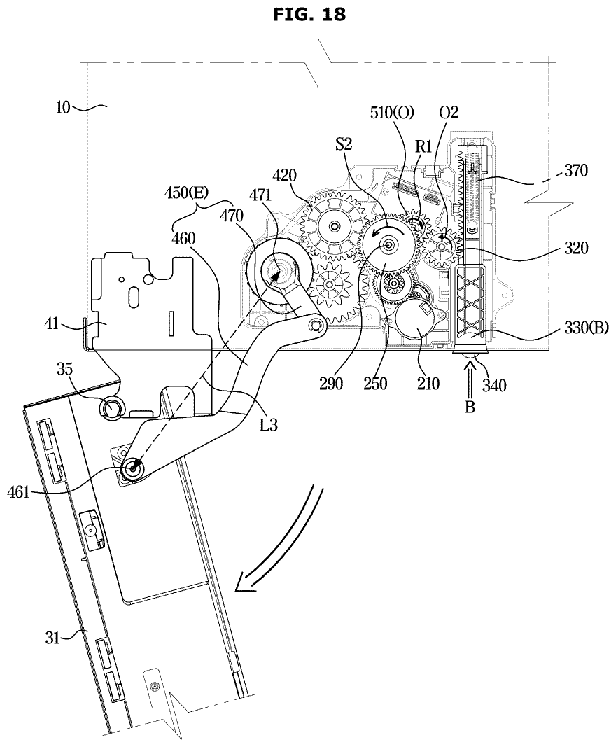

The drive portion 200 may include a sun gear 250 connected to the drive motor 210 via the drive gear train 220. The sun gear 250 may rotate in one direction in accordance with a driving direction of the drive motor 210. For example, when the drive motor 210 is driven in a forward direction, the sun gear 250 may rotate in a first direction S1 (see FIG. 16), and when the drive motor 210 is driven in a reverse direction, the sun gear 250 may rotate in a second direction S2 (see FIG. 18), which is the opposite of the first direction.

As used herein, the first direction may be a clockwise direction when viewed from above, and the second direction may be a counterclockwise direction when viewed from above, but is not limited thereto and may be the opposite.

According to an embodiment of the present disclosure, the sun gear 250 may have a shape of a two-stage spur gear in which two spur gears are coupled to one shaft. In other words, the sun gear 250 may include an upper sun gear 251 and a lower sun gear 252 having a smaller radius than the upper sun gear 251. According to an embodiment of the present disclosure, the upper sun gear 251 may be meshed with the second drive gear 240, and the lower sun gear 252 may be meshed with a planetary gear 510.

The drive portion 200 may include a sun gear pin 290 configured to pass through a central portion of the sun gear 250 to guide rotation of the sun gear 250. In other words, the sun gear pin 290 may form an axis of rotation of the sun gear 250. In addition, the sun gear pin 290 may form an axis of revolution of the planetary gear 510, which will be described later.

The sun gear pin 290 may be supported by a shaft support portion 150 (see FIG. 11) formed in the lower housing 140. The sun gear pin 290 may be inserted into and supported by the shaft support portion 150 formed in the lower housing 140.

The sun gear 250 may include a shaft hole 260 formed in a central portion of the sun gear 250 to allow the sun gear pin 290 to be inserted.

The push portion 300 may include the push rod 330 configured to push the door 31 to open the door 31, and an opening gear train 310 connected to the push rod 330 to move the push rod 330.

The push rod 330 may be received in a push rod receiving portion 160 provided in the housings 110 and 140. The push rod receiving portion 160 may be provided in the upper housing 110 or the lower housing 140 in a recessed form.

The push rod 330 may have a rod shape. A pressing portion 340 for contacting and pressing the door 31 may be provided at one end portion of the push rod 330 in a longitudinal direction. The pressing portion 340 may include a roller to mitigate shock and friction generated when pressing the door 31.

A linear rack gear portion 350 meshed with an opening gear 320 of the opening gear train 310 may be provided on one side of the push rod 330 in the longitudinal direction. When the opening gear 320 rotates, the rack gear portion 350 may move in a linear direction. Accordingly, depending on a direction of rotation of the opening gear 320 the push rod 330 may advance in a direction toward the door 31 or retract in an opposite direction.

The opening gear train 310 may include at least one opening gear. According to an embodiment of the present disclosure, the opening gear train 310 may be configured with only one opening gear 320. However, the present disclosure is not limited thereto, and the opening gear train 310 may be configured with a plurality of opening gears.

The push rod 330 may move linearly between a maximum advanced position and a maximum retracted position. In the following, reference numeral 330(F) may refer to the push rod at the maximum advanced position or the maximum advanced position. In addition, reference numeral 330(B) may refer to the push rod at the maximum retracted position or the maximum retracted position.

As shown in FIG. 12, the push portion 300 may include an elastic member 370 that elastically biases the push rod 330 to the maximum retracted position 330(B).

The elastic member 370 may include a tension spring. One end 371 of the elastic member may be fixed to the housings 110 and 140. The upper housing 110 or the lower housing 140 may be formed with an elastic member fixing portion 170 to which the one end 371 of the elastic member is fixed. The other end 372 of the elastic member may be fixed to the push rod 330. To this end, an elastic member fixing portion 360 to which the other end 372 of the elastic member is fixed may be provided on the push rod 330.

The linkage portion 400 may include a link 450 connected to the door 31 to close the door 31, and a closing gear train 410 connected to the link 450 to move the link 450.

The link 450 may include a plurality of link rods connected to each other. In an example, the link 450 may include a first link rod 460 and a second link rod 470 connected to the first link rod 460.

Specifically, one end of the first link rod 460 may be coupled to the door 31, and one end of the second link rod 470 may be coupled to one closing gear 440 of the closing gear train 410. The other end of the first link rod 460 and the other end of the second link rod 470 may be rotatably coupled to each other.

The first link rod 460 may include a door coupling portion 461 formed at one end of the first link rod 460. The door coupling portion 461 may have a hole shape, and the door 31 may be provided with a coupling protrusion inserted into and coupled to the door coupling portion 461.

The second link rod 470 may include a gear coupling portion 471 formed at one end of the second link rod 470 to be coupled to the closing gear 440. The gear coupling portion 471 may have a disc shape. A central portion of the gear coupling portion 471 may be opened for coupling of a retention cap 491, which will be described later. The gear coupling portion 471 may be coupled to the closing gear 440 via a fastening member SC1 such as a screw, a nail, a rivet, a pin, or the like. With such a structure, the closing gear 440 and the second link rod 470 may rotate together.

Specifically, in response to the closing gear 440 rotating about a rotation axis of the closing gear 440, the second link rod 470 may also rotate about the rotation axis of the closing gear 440. Conversely, in response to the second link rod 470 rotating about the rotation axis of the closing gear 440, the closing gear 440 may also rotate about the rotation axis of the closing gear 440.

The gear coupling portion 471 may be coupled to an upper side of the closing gear 440. An opening 120 may be formed in the upper housing 110 for coupling the gear coupling portion 471 and the closing gear 440. An opening cover 490 for covering the opening 120 may be coupled between the gear coupling portion 471 and the closing gear 440. The retention cap 491 for preventing detachment of the second link rod 470 may be provided on an upper side of the gear coupling portion 471. The retention cap 491 may be coupled to the lower housing 140 by a fastening member SC2.

The link 450 may include a connecting pin 480 that rotatably couples the first link rod 460 and the second link rod 470. The connecting pin 480 may pass through a connecting hole formed at the other end of the first link rod 460 and a connecting hole formed at the other end of the second link rod 470. A washer 481 may be interposed between the other end of the first link rod 460 and the other end of the second link rod 470. The washer 481 may prevent direct contact between the other end of the first link rod 460 and the other end of the second link rod 470 to prevent friction and wear. An anti-separation disc 482 for preventing separation of the first link rod 460 and the second link rod 470 may be coupled to an upper end of the connecting pin 480.

The link 450 may be movable between a folded position and a fully extended position. Hereinafter, reference numeral 450(F) may refer to the link in the folded position or the folded position. In addition, reference numeral 450(E) may refer to the link in the fully extended position or the fully extended position. In addition, reference numeral 450(P) may refer to the link in a partially extended position or the partially extended position.

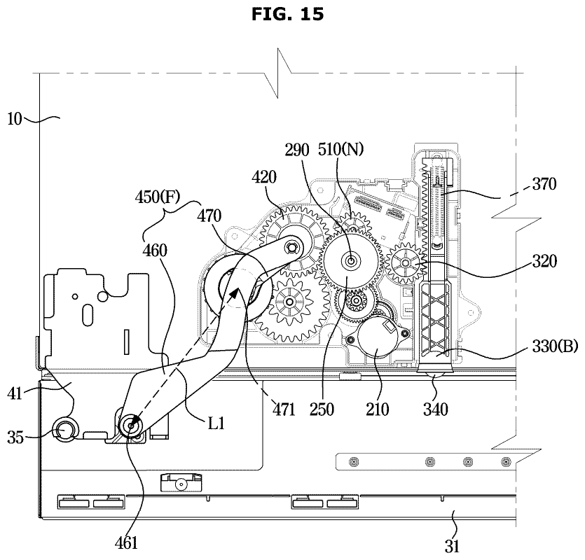

As shown in FIG. 15, when the door 31 is in a closed state, the link 450 may be in the folded position 450(F). When the link 450 is in the folded position 450(F), a linear distance L1 between the door coupling portion 461 of the first link rod 460 and the gear coupling portion 471 of the second link rod 470 may be minimized.

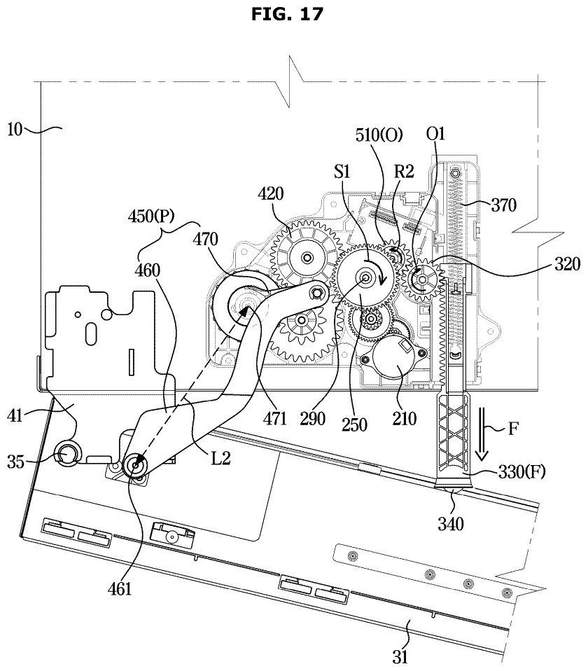

As shown in FIG. 17, when the door 31 is in a partially open state, the link 450 may be in the partially extended position 450(P). When the link 450 is in the partially extended position 450(P), a linear distance L2 between the door coupling portion 461 of the first link rod 460 and the gear coupling portion 471 of the second link rod 470 may be an intermediate distance between a minimum distance and a maximum distance.

As shown in FIG. 18, when the door 31 is in a fully open state, the link 450 may be in the fully extended position 450(E). When the link 450 is in the fully extended position 450(E), a linear distance L3 between the door coupling portion 461 of the first link rod 460 and the gear coupling portion 471 of the second link rod 470 may be maximized.

The closing gear train 410 may include at least one closing gear. In an example, the closing gear train 410 may include a first closing gear 420 that may be meshed with the planetary gear 510, a second closing gear 430 meshed with the first closing gear 420, and a third closing gear 440 meshed with the second closing gear 430. The first link rod 470 described above may be coupled to the third closing gear 440.

The clutch portion 500 may transmit the driving force generated by the drive motor 210 to the push portion 300 or the linkage portion 400. To this end, the clutch portion 500 may include the planetary gear 510 movable between an open position connected to the opening gear train 310 and a closed position connected to the closing gear train 410.

Hereinafter, reference numeral 510(O) may refer to the planetary gear 510 in the open position or the open position. In addition, reference numeral 510(C) may refer to the planetary gear 510 in the closed position or the closed position. In addition, reference numeral 510(N) may refer to the planetary gear in a neutral position between the open position and the closed position or a neutral position.

The planetary gear 510 may be provided to be meshed with the sun gear 250 regardless of its position. Accordingly, when the planetary gear 510 is in the open position 510(O), the driving force of the drive motor 210 may be transmitted to the opening gear train 310 via the sun gear 250 and the planetary gear 510, and when the planetary gear 510 is in the closed position 510(C), the driving force of the drive motor 210 may be transmitted to the closing gear train 410 via the sun gear 250 and the planetary gear 510.

As shown in FIG. 15, when the sun gear 250 rotates while the planetary gear 510 is in the neutral position 510(N) between the open position 510(O) and the closed position 510(C), the planetary gear 510 may revolve around the sun gear 250 in conjunction with the rotation of the sun gear 250.

As used herein, the term “revolution” may refer to the planetary gear 510 rotating around another configuration (e.g., sun gear), and the term “rotation on its axis” may refer to the planetary gear 510 rotating about its own central axis, a planetary gear pin 540. In addition, the term “rotate” may be the same as the term “rotate on its axis”. However, in the present disclosure, the planetary gear 510 may perform both revolution and rotation, such that the terms revolution and rotation may be used for the planetary gear 510 to distinguish them, and the term rotation may be used for the remaining configurations.

As shown in FIG. 17, when the sun gear 250 rotates while the planetary gear 510 is in the open position 510(O), the planetary gear 510 may rotate on its axis in conjunction with the rotation of the sun gear 250. In conjunction with the rotation on its axis of the planetary gear 510, at least one opening gear 320 may rotate. In conjunction with the rotation of the at least one opening gear 320, the push rod 330 may move linearly.

In other words, when the planetary gear 510 is in the open position 510(O), the planetary gear 510 may transmit the rotational force of the sun gear 250 to the at least one opening gear 320, and the rotational force transmitted to the at least one opening gear 320 may allow the push rod 330 to move linearly.

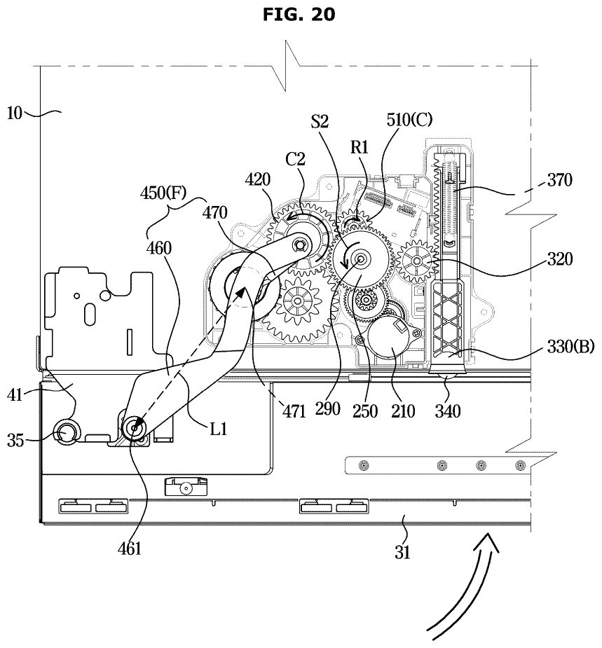

As shown in FIG. 20, when the sun gear 250 rotates while the planetary gear 510 is in the closed position 510(C), the planetary gear 510 may rotate on its axis in conjunction with the rotation of the sun gear 250. In conjunction with the rotation on its axis of the planetary gear 510, at least one closing gear 420, 430 and 440 may rotate. In conjunction with the rotation of the at least one closing gear 420, 430 and 440, the link 450 may move.

In other words, when the planetary gear 510 is in the closed position 510(C), the planetary gear 510 may transmit the rotational force of the sun gear 250 to the at least one closing gear 420, 430 and 440, and the link 450 may be moved by the rotational force transmitted to the at least one closing gear 420, 430 and 440.

As such, the planetary gear 510 may have a behavior that varies depending on the position of the planetary gear 510.

When the planetary gear 510 is in the neutral position 510(N), i.e., when the planetary gear 510 is not connected to the opening gear train 310 or the closing gear train 410, the planetary gear 510 may revolve around the sun gear 250 in conjunction with the rotation of the sun gear 250.

When the planetary gear 510 is in the open position 510(O) or the closed position 510(C), i.e., when the planetary gear 510 is connected to the opening gear train 310 or the closing gear train 410, the planetary gear 510 may rotate on its axis in conjunction with the rotation of the sun gear 250.

As shown in FIG. 9, to allow the above motion of the planetary gear 510 to be performed, the clutch portion 500 may include a carrier plate 520 rotatably provided about the sun gear pin 290 and on which the planetary gear 510 is mounted, and a friction member 530 that generates a frictional force between the planetary gear 510 and the carrier plate 520 to allow the planetary gear 510 to revolve around the sun gear 250 in conjunction with the rotation of the sun gear 250.

The clutch portion 500 may include the planetary gear pin 540 provided on the carrier plate 520 to pass through a central portion of the planetary gear 510 to guide the rotation on its axis of the planetary gear 510. The planetary gear pin 540 may form an axis of rotation of the planetary gear 510. The planetary gear pin 540 and the sun gear pin 290 are spaced apart and parallel to each other.

A shaft hole 515 into which the planetary gear pin 540 is inserted may be formed in the central portion of the planetary gear 510. The planetary gear pin 540 may include a retaining slot 541 to receive a retaining ring 550 to hold the planetary gear 540 on the planetary gear pin 540.

The planetary gear pin 540 may be disposed perpendicularly to an upper surface of the carrier plate 520. The carrier plate 520 may include a pin receiving portion 522 formed on the upper surface of the carrier plate 520 to which the planetary gear pin 540 is inserted and fixed.

The carrier plate 520 may include a shaft hole 525 into which the shaft support portion 150 of the lower housing 140 is inserted. The carrier plate 520 may rotate about the shaft support portion 150 inserted into the shaft hole 525.

The friction member 530 may be disposed between the planetary gear 510 and the carrier plate 520. The friction member 530 may provide a frictional force between the planetary gear 510 and the carrier plate 520 such that the planetary gear 510 revolves without rotating on its axis during the rotation of the sun gear 250.

Since the carrier plate 520 is configured to rotate about the sun gear pin 290, the planetary gear 510 mounted on the carrier plate 520 may also revolve about the sun gear pin 290 in the process of the carrier plate 520 rotating about the sun gear pin 290. In other words, the revolution of the planetary gear 510 may be guided by the carrier plate 520.

A compression spring may be used as the friction member 530. One end portion 531 of the friction member 530 may be supported on a lower surface of the planetary gear 510, and the other end portion 532 of the friction member 530 may be supported on the upper surface of the carrier plate 520. However, the friction member 530 is not limited to a compression spring, and need not be a compression spring as long as it is capable of providing a frictional force between the planetary gear 510 and the carrier plate 520.

With such a structure, when the planetary gear 510 is positioned between the open position 510(O) and the closed position 510(C), the planetary gear 510 may revolve in conjunction with the rotation of the sun gear 250.

In contrast, when the planetary gear 510 is in the open position 510(O), the planetary gear 510 may be meshed with the opening gear 320 whose shaft is fixed. Accordingly, the revolution of the planetary gear 510 is restricted at this time, and the planetary gear 510 may rotate on its axis in conjunction with the rotation of the sun gear 250.

When the planetary gear 510 is in the closed position 510(C), the planetary gear 510 may be meshed with the closing gear 440 whose shaft is fixed. Accordingly, the revolution of the planetary gear 510 is restricted at this time, and the planetary gear 510 may rotate on its axis in conjunction with the rotation of the sun gear 250.

Referring to FIG. 10, the refrigerator 1 may include position sensors 840 and 850 configured to detect the position of the planetary gear 510. The position sensors 840 and 850 may include a Hall sensor that detects a magnetic field and generates an electrical signal. The Hall sensor may include a Hall element made of a semiconductor. The position sensors 840 and 850 may be arranged on a printed circuit board 830 that supplies current to the position sensors 840 and 850 and processes the generated signal. The position sensors 840 and 850 may detect the position of the planetary gear 510 in a non-contact manner without directly contacting the planetary gear 510.

A magnet mounting portion 591 of the carrier plate 520 may be provided with a magnet 590. The magnet 590 may move together with the movement of the carrier plate 520, and the resulting changed in the magnetic field may be detected by the position sensors 840 and 850.

The position sensors 840 and 850 may be digital Hall sensors that use a comparator to convert a signal to on or off. In other words, the position sensors 840 and 850 may output High (i.e., a high signal) when a magnetic field above a certain threshold is detected, and output Low (i.e., a low signal) otherwise.

The position sensors 840 and 850 may include an open position sensor 840 that detects whether the planetary gear 510 is in the open position 510(O), and a closed position sensor 850 that detects whether the planetary gear 510 is in the closed position 510(C).

The position sensors 840 and 850 may identify the planetary gear 510 as being in the neutral position 510(N) when both the open position sensor 840 and the closed position sensor 850 output off.

However, unlike the present embodiment, there is no limitation on the number of position sensors. In an example, an additional position sensor capable of directly detecting the neutral position 510(N) of the planetary gear 510 may be further provided.

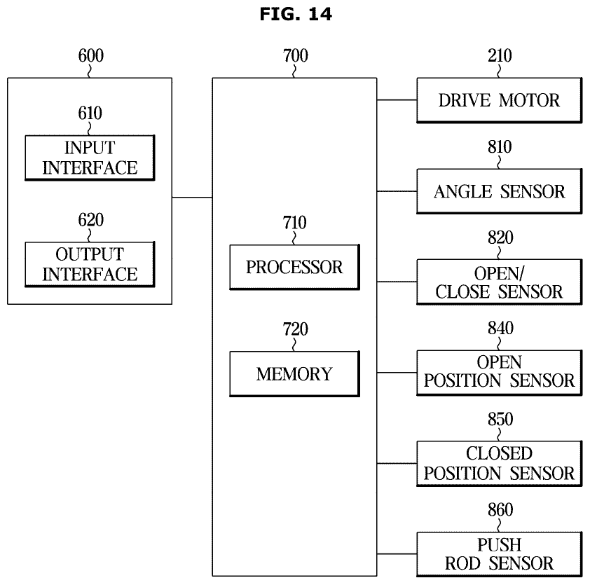

FIG. 14 is a block diagram illustrating a control configuration of the refrigerator according to an embodiment of the present disclosure.

Referring to FIG. 14, the refrigerator 1 may include a user interface 600 that receives a user input and outputs information related to an operation of the refrigerator. The user interface 600 may be provided on a door.

The user interface 600 may include an input interface 610 for receiving a user input and an output interface 620 for outputting information related to an operation of the refrigerator.

The input interface 610 may receive a user input and transmit it to a controller 700. The input interface 610 may receive a target temperature of a storage compartment and may receive a storage mode of the storage compartment. Here, the storage mode may include a freezing mode, a refrigerating mode, a Kimchi mode, a vegetable mode, and the like. The input interface 610 may receive an open command for a door.

The input interface 610 may include a hardware device such as a key, a button, a switch, a pedal, a mouse, a track-ball, or a microphone. The input interface 610 may include a GUI (Graphical User interface), i.e., a software device, such as a touch pad. The touch pad may be implemented as a Touch Screen Panel (TSP) and may form a mutual layer structure with a display unit.

The output interface 620 may output guidance information about automatic opening of a door or guidance information about automatic closing of a door. The output interface 620 may include a display unit and a speaker.

The display unit may display information related to a state or operation of the refrigerator 1 based on a control command of the controller 700, and display information for guiding a user's input. The display unit may display information input to the input interface 610. The display unit may display a target temperature and a storage mode of a storage compartment. The display unit may display an open state and a closed state of a door.

The display unit may include a plurality of seven-segments. The display unit may be provided as a liquid crystal display (LCD), a Digital Light Processing (DLP) panel, a plasma display panel (PDP), an Electro Luminescence (EL) panel, an Electrophoretic Display (EPD) panel, an Electrochromic Display (ECD) panel, a Light Emitting Diode (LED) panel, or an Organic Light Emitting Diode (OLED) panel, but is not limited thereto.

The speaker may output guidance sound information related to a state or operation of the refrigerator 1 based on a control command of the controller 700, and output guidance sound information for guiding a user's input. The speaker may output a guidance sound corresponding to a change in the target temperature of a storage compartment or output a guidance sound corresponding to a change in the storage mode of the storage compartment. The speaker may output a guidance sound for automatic opening of a door or a guidance sound for automatic closing of a door.

The refrigerator 1 may include an angle sensor 810 that detects an opening angle of a door. The angle sensor 810 may detect the opening angle of the door and transmit information about the detected opening angle of the door to the controller 700. The opening angle of the door in a closed state may be 0 degrees.

The angle sensor 810 may detect the opening angle of the door by various methods. For example, the angle sensor 810 may detect the opening angle of the door by detecting a rotation angle of the third closing gear 440. The angle sensor 810 may be provided as an optical sensor or a Hall sensor.

The refrigerator 1 may include an open/close sensor 820 that detects a position of a door and outputs door position information corresponding to the detected position of the door. Here, the position of the door may include an open position and a closed position.

The open/close sensor 820 may include a micro switch, a limit switch, a magnetic switch, a reed switch, a toggle switch, a tact switch, or the like. The open/close sensor 820 may include an optical sensor, an ultrasonic sensor, or an impact sensor, but is not limited thereto.

The door opening/closing device 100 may include a push rod sensor 860 that detects the position of the push rod 330.

The controller 700 may be electrically connected to various components of the refrigerator and may control the various components. That is, the controller 700 may control an overall operation of the refrigerator 1. The controller may include a memory 720 for storing or memorizing programs and/or data for controlling the refrigerator, and a processor 710 for outputting a control signal for controlling a cold air supply device and the drive motor 210 according to the programs and/or data stored in the memory.

The controller 700 may control an operation of the refrigerator 1 based on a user input received by the input interface 610. The controller 700 may control the output interface 620 so that output information related to the operation of the refrigerator 1 is output.

The controller 700 may receive a target temperature of a storage compartment from the input interface 610 and control the output interface 620 to display the received target temperature of the storage compartment. The controller 700 may control an operation of a cooling system based on the target temperature of the storage compartment and a temperature detected by a temperature sensor (not shown) of the storage compartment.

Hereinafter, an operation of the door opening/closing device and an opening/closing operation of a door according thereto, according to an embodiment of the present disclosure, will be described with reference to the drawings.

FIG. 15 illustrates the door 31 in a closed state and the door opening/closing device 100 in an initial state.

When the door opening/closing device 100 is in the initial state, the planetary gear 510 may be in the neutral position 510(N).

When the door opening/closing device 100 is in the initial state, the push rod 330 may be in the maximum retracted position 330(B). The push rod 330 may be in a state of being elastically biased to the maximum retracted position 330(B) by the elastic member 370.

When the door opening/closing device 100 is in the initial state, the link 450 may be in the folded position 450(F). When the link 450 is in the folded position 450(F), the linear distance L1 between the door coupling portion 461 of the first link rod 460 and the gear coupling portion 471 of the second link rod 470 may be minimized.

FIG. 16 is a view illustrating a state in which the planetary gear has moved to an open position as the planetary gear revolves in conjunction with rotation of the sun gear.

When a door open command is received from a user at the input interface 610, the controller 700 may control the door opening/closing device 100. The controller 700 may control the drive motor 210 so that a motor shaft of the drive motor 210 rotates in a forward direction based on the door open command being received by the input interface 610.

A forward driving force of the drive motor 210 may be transmitted to the sun gear 250 through the drive gear train 220. For example, when the drive motor 210 is driven in the forward direction, the sun gear 250 may rotate in the first direction S1.

In conjunction with the rotation of the sun gear 250 in the first direction S1, the planetary gear 510 may revolve around the sun gear 250 in a first revolution direction REV1. Here, the first direction S1 and the first revolution direction REV1 are the same direction.

The planetary gear 510 may revolve in the first revolution direction REV1 until it is meshed with the opening gear 320. When the planetary gear 510 starts to be meshed with the opening gear 320, the revolution of the planetary gear 510 may be restricted by a resistance of the opening gear 320.

FIG. 17 is a view illustrating a state in which the push rod has advanced to a maximum advanced position as the planetary gear rotates on its axis in conjunction with rotation of the sun gear.

When the sun gear 250 rotates in the first direction S1 while the planetary gear 510 is meshed with the opening gear 320, the planetary gear 510 may rotate on its axis in a second rotation direction R2. Here, the second rotation direction R2 is opposite to the first direction S1.

In conjunction with the rotation of the planetary gear 510 in the second rotation direction R2, the opening gear 320 may rotate in a first direction O1. Here, the first direction O1 is opposite to the second rotation direction R2.

In conjunction with the rotation of the opening gear 320 in the first direction O1, the push rod 330 may move linearly forward (F) to the maximum advanced position 330(F). In the process of the push rod 330 advancing, the push rod 330 may press the door 31 to open the door 31.

As shown in FIG. 17, when the forward driving of the drive motor 210 is stopped, the planetary gear 510 is in the open position 510(O), the push rod 330 is in the maximum advanced position 330(F), and the link 450 is in the partially extended position 450(P).

When the link 450 is in the partially extended position 450(P), the linear distance L2 between the door coupling portion 461 of the first link rod 460 and the gear coupling portion 471 of the second link rod 470 may be a distance between the minimum linear distance L1 and the maximum linear distance L3.

At this time, the elastic member 370 may be maximally extended, and elastic force may be maximally accumulated in the elastic member 370.

FIG. 18 is a view illustrating a state in which the push rod has returned to the maximum retracted position by the elastic force of the elastic member.

When the forward driving of the drive motor 210 is stopped, the push rod 330 may move linearly backward (B) to the maximum retracted position 330(B) by the elastic force of the elastic member 370.

Since the rack gear portion 350 of the push rod 330 is meshed with the opening gear 320, the opening gear 320 may rotate in a second direction O2 in conjunction with the backward movement of the push rod 330.

In conjunction with the rotation of the opening gear 320 in the second direction O2, the planetary gear 510 may rotate on its axis in a first rotation direction R1, and in conjunction with the rotation on its axis of the planetary gear 510 in the first rotation direction R1, the sun gear 250 may rotate in a second direction S2. The rotational force of the sun gear 250 may be transmitted to the drive gear train 220 and the drive motor 210.

As such, the push rod 330 may be restored backward (B) by the elastic force of the elastic member 370 while being meshed with the opening gear 320. Therefore, in the process of restoring the push rod 330 backward, the opening gear 320, the planetary gear 510, the sun gear 250, the drive gear train, the drive motor 210, and the like may act as a load.

Thus, the speed of the return operation of the push rod 330 may be reduced, and noise generated due to rapid return and collision of the push rod 330 may be reduced. In addition, the return operation of the push rod 330 may be performed smoothly.

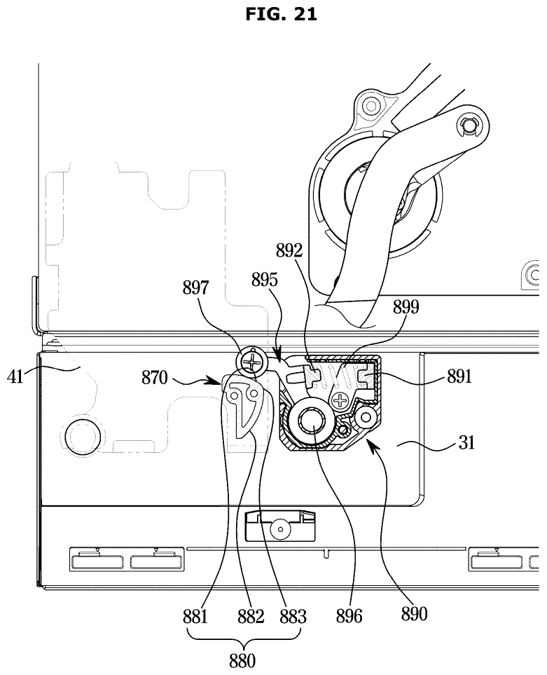

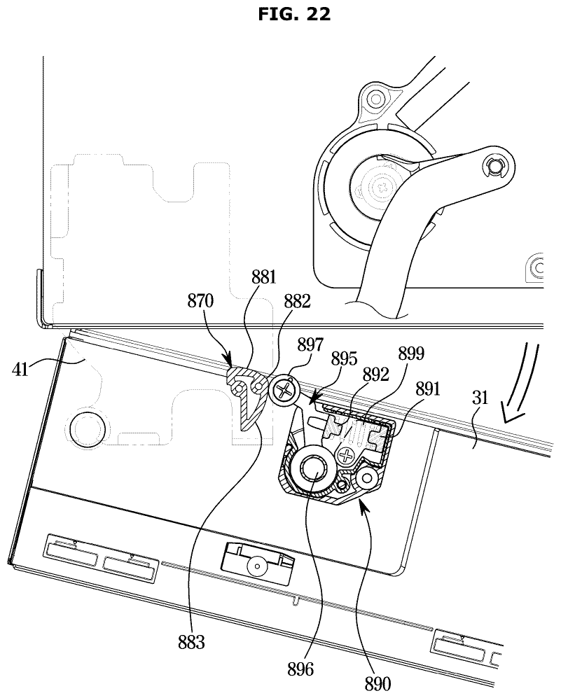

Simultaneously with the return operation of the push rod 330, the door 31 may be opened to a larger opening angle by inertia or a separate cam structure (see FIGS. 21 and 22), or the like. That is, the door 31 may be opened to a maximum opening angle.

In the process of the door 31 being opened to the maximum opening angle, the link 450 may be further extended. That is, as the door 31 is opened to the maximum opening angle, the link 450 may reach the fully extended position 450(E).

When the link 450 is in the fully extended position 450(E), the linear distance L3 between the door coupling portion 461 of the first link rod 460 and the gear coupling portion 471 of the second link rod 470 may be maximized.

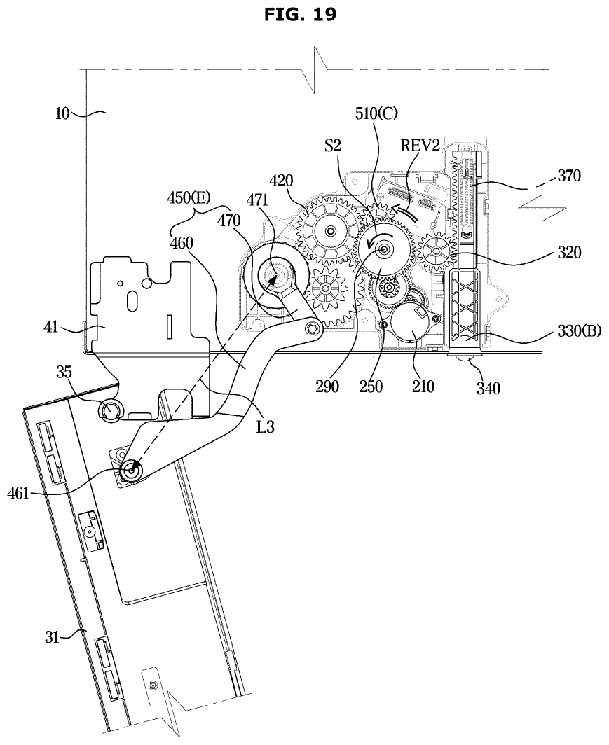

FIG. 19 is a view illustrating a state in which the planetary gear has moved to a closed position as the planetary gear revolves around the sun gear in conjunction with rotation of the sun gear.

When a door close command is received from a user at the input interface 610, the controller 700 may control the door opening/closing device 100. The controller 700 may control the drive motor 210 so that a motor shaft of the drive motor 210 rotates in a reverse direction, which is opposite to the forward direction, based on the door close command being received by the input interface 610.

A forward driving force of the drive motor 210 may be transmitted to the sun gear 250 through the drive gear train 220. For example, when the drive motor 210 is driven in the reverse direction, the sun gear 250 may rotate in the second direction S2.

In conjunction with the rotation of the sun gear 250 in the second direction S2, the planetary gear 510 may revolve around the sun gear 250 in a second revolution direction REV2. Here, the second direction S2 and the second revolution direction REV2 are the same direction.

The planetary gear 510 may revolve in the second revolution direction REV2 until it is meshed with the closing gear 420. When the planetary gear 510 starts to be meshed with the closing gear 420, the revolution of the planetary gear 510 may be restricted by a resistance of the closing gear 420.

As shown in FIG. 19, in a state where the planetary gear 510 has started to be meshed with the closing gear 420 of the closing gear train, the planetary gear 510 is in the closed position 510(C), the push rod 330 is in the maximum retracted position 330(B), and the link 450 is in the fully extended position 450(E).

FIG. 20 is a view illustrating a state in which the link is folded to the folded position as the planetary gear rotates on its axis in conjunction with the rotation of the sun gear.

When the sun gear 250 rotates in the second direction S2 while the planetary gear 510 is meshed with the closing gear 420, the planetary gear 510 may rotate on its axis in the first rotation direction R1. Here, the first rotation direction R1 is the opposite direction of the second direction S2.

In conjunction with the rotation of the planetary gear 510 in the first rotation direction R1, the closing gear 420 may rotate in a second direction C2. Here, the second direction C2 is the opposite direction of the first rotation direction R1.

In conjunction with the rotation of the closing gear 420, the closing gear 430 and the closing gear 440 may rotate, and in conjunction with the rotation of the closing gear 440, the second link rod 470 of the link 450 may rotate.

As the second link rod 470 rotates, the link 450 may move to the folded position 450(F), and as the link 450 moves to the folded position 450(F), the door 31 connected to the link 450 may be closed.

FIG. 21 is a view illustrating a cam and a lever device in a door closed state of FIGS. 15 and 16. FIG. 22 is a view illustrating the cam and the lever device when the push rod of FIG. 17 is in the maximum advanced position.

Referring to FIGS. 21 and 22, an operation of the door 31 being opened to a greater opening angle by a cam structure after the push rod 330 is advanced to the maximum advanced position will be described.

The refrigerator 1 may include a cam 870 coupled to the hinge 41 and a lever device 890 coupled to the door.

The cam 870 may be coupled to a lower surface of the hinge 41. The cam 870 may include a guide surface 880. The guide surface 880 may form a portion of an outer surface of the cam 870.

The guide surface 880 may include a first contact surface 881 configured to allow a lever 895, which will be described later, to apply a force in a direction of closing to the door 31 when the lever 895 is contacted, a second contact surface 882 configured to the lever 895 to transmit a force in a direction of opening the door 31 when the lever 895 is contacted, and an inflection point 883 provided between the first contact surface 881 and the second contact surface 882.

The first contact surface 881 and the second contact surface 882 may be connected to each other based on the inflection point 883. In response to the door being opened, the lever 895 in contact with the cam 870 may move sequentially past the first contact surface 881, the inflection point 883, and the second contact surface 882.

The lever device 890 may be coupled to an upper portion of the door 31.

The lever device 890 may include the lever 895 configured to contact the cam 870 when the door 31 is opened or closed, and an elastic member 899 connected to the lever 895 and configured to be compressed or extended when the lever 895 is moved relative to the door 31.

The lever 895 may be configured to be rotatable about a lever rotation axis 896. The lever 895 may include a roller 897 configured to contact the cam 870.

The elastic member 899 may be provided such that an elastic force is maximally accumulated when the lever 895 contacts the inflection point 883, may be compressed by the lever 895 when the lever 895 contacts the first contact surface 881 and moves toward the inflection point 883, and may apply an elastic force in a direction of opening the door 31 when the lever 895 contacts the second contact surface 882 and moves in a direction away from the inflection point 883.

The lever device 890 may include a first support protrusion 891 on which one end of the elastic member 899 is supported, and a second support protrusion 892 on which the other end of the elastic member 899 is supported.

In a state where the push rod 330 is advanced to the maximum advanced position, the lever 895 may contact the second contact surface 882 past the inflection point 883. In other words, the push rod 330 may be advanced until the lever 895 contacts the second contact surface 882 past the inflection point 883.

With such a configuration, the door 31 may continue to open by elastic force or inertia after the push rod 330 has advanced to the maximum advanced position, and may open to the maximum opening angle.

Hereinafter, a specific control method when an open command and a close command are received will be described with reference to the drawings.

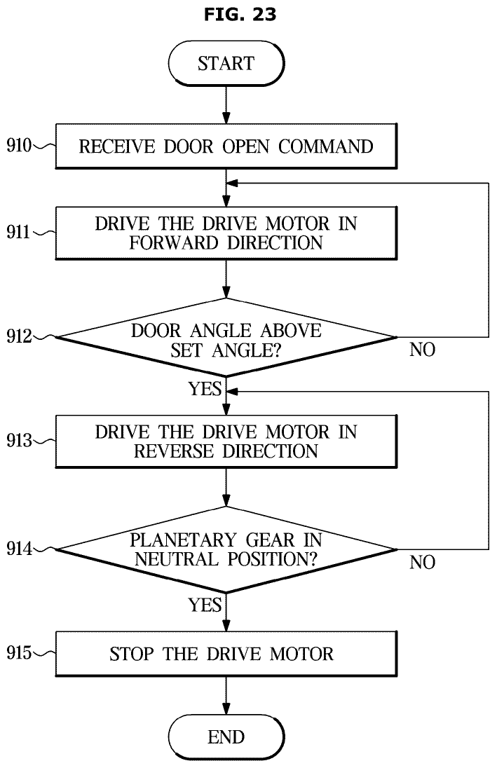

FIG. 23 is a view illustrating a control flow when an open command is received according to an embodiment of the present disclosure.

The door open command may be received from the input interface 610 (910).

The controller 700 may drive the drive motor 210 in the forward direction until the controller 700 recognizes that the door has been opened to a set angle based on the door open command being received through the input interface 610 (911, 912).

Specifically, the controller 700 may recognize that the door has been opened to the set angle based on the opening angle of the door detected by the angle sensor 810 reaching the set angle.

Alternatively, the controller 700 may recognize that the door has been opened to the set angle based on a drive motor FG count value reaching a set FG count value after forward driving of the drive motor 210 is initiated.

Alternatively, the controller 700 may recognize that the door has been opened to the set angle based on a set time elapsing after forward driving of the drive motor 210 begins.

Alternatively, the controller 700 may recognize that the door has been opened to the set angle based on the drive motor FG count value reaching the set FG count value after detecting that the planetary gear 510 has reached the open position 510(O) by the open position sensor 840.

Alternatively, the controller 700 may recognize that the door has been opened to the set angle based on the set time elapsing after detecting that the planetary gear 510 has reached the open position 510(O) by the open position sensor 840.

The controller 700 may drive the drive motor 210 in the reverse direction until the controller 700 recognizes that the planetary gear 510 has reached the neutral position 510(N) based on recognizing that the door has been opened to the set angle (913, 914).

Specifically, the controller 700 may recognize that the planetary gear 510 has reached the neutral position 510(N) based on the drive motor FG count value reaching the set FG count value after reverse driving of the drive motor 210 is initiated.

Alternatively, the controller 700 may recognize that the planetary gear 510 has reached the neutral position 510(N) based on the set time elapsing after reverse driving of the drive motor 210 begins.

Alternatively, the controller 700 may recognize that the planetary gear 510 has reached the neutral position 510(N) based on detecting that the planetary gear 510 has reached the neutral position 510(N) by the position sensors 840 and 850.

The controller 700 may stop the drive motor 210 based on recognizing that the planetary gear 510 has reached the neutral position 510(N) (915).

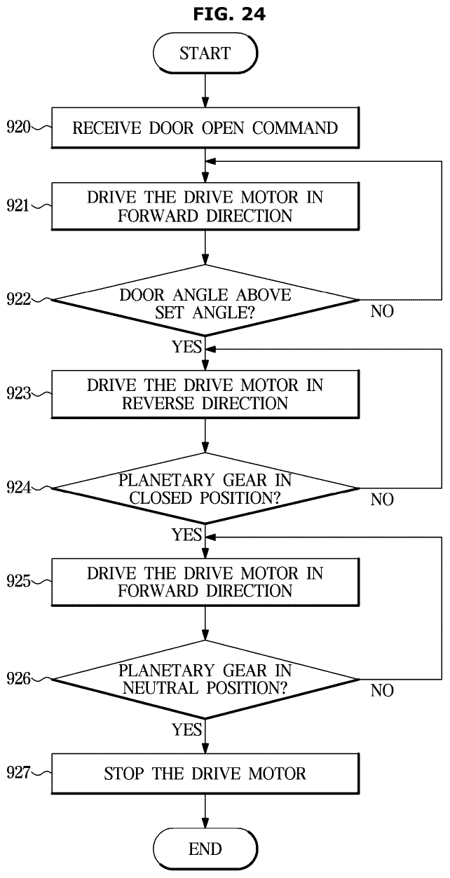

FIG. 24 is a view illustrating a control flow when an open command is received according to an embodiment of the present disclosure.

The door open command may be received from the input interface 610 (920).

The controller 700 may drive the drive motor 210 in the forward direction until the controller 700 recognizes that the door has been opened to a set angle based on the door open command being received through the input interface 610 (921, 912).

Specifically, the controller 700 may recognize that the door has been opened to the set angle based on the opening angle of the door detected by the angle sensor 810 reaching the set angle.

Alternatively, the controller 700 may recognize that the door has been opened to the set angle based on a drive motor FG count value reaching a set FG count value after forward driving of the drive motor 210 is initiated.

Alternatively, the controller 700 may recognize that the door has been opened to the set angle based on a set time elapsing after forward driving of the drive motor 210 begins.

Alternatively, the controller 700 may recognize that the door has been opened to the set angle based on the drive motor FG count value reaching the set FG count value after detecting that the planetary gear 510 has reached the open position 510(O) by the open position sensor 840.

Alternatively, the controller 700 may recognize that the door has been opened to the set angle based on the set time elapsing after detecting that the planetary gear 510 has reached the open position 510(O) by the open position sensor 840.

The controller 700 may drive the drive motor 210 in the reverse direction until the controller 700 recognizes that the planetary gear 510 has reached the closed position 510(C) based on recognizing that the door has been opened to the set angle (923, 924).

Specifically, the controller 700 may recognize that the planetary gear 510 has reached the closed position 510(C) based on the drive motor FG count value reaching the set FG count value after reverse driving of the drive motor 210 is initiated.

Alternatively, the controller 700 may recognize that the planetary gear 510 has reached the closed position 510(C) based on the set time elapsing after reverse driving of the drive motor 210 begins.

Alternatively, the controller 700 may recognize that the planetary gear 510 has reached the closed position 510(C) based on detecting that the planetary gear 510 has reached the closed position 510(C) by the closed position sensor 850.

Based on recognizing that the planetary gear 510 has reached the closed position 510(C), the controller 700 may drive the drive motor 210 in the forward direction until the controller 700 recognizes that the planetary gear 510 is about to reach the neutral position 510(N), (925, 926).

Specifically, the controller 700 may recognize that the planetary gear 510 has reached the neutral position 510(N) based on the drive motor FG count value reaching the set FG count value after forward driving of the drive motor 210 is initiated.

Alternatively, the controller 700 may recognize that the planetary gear 510 has reached the neutral position 510(N) based on the set time elapsing after forward driving of the drive motor 210 begins.

Alternatively, the controller 700 may recognize that the planetary gear 510 has reached the neutral position 510(N) based on detecting that the planetary gear 510 has reached the neutral position 510(N) by the position sensors 840 and 850.

The controller 700 may stop the drive motor 210 based on recognizing that the planetary gear 510 has reached the neutral position 510(N) (927).

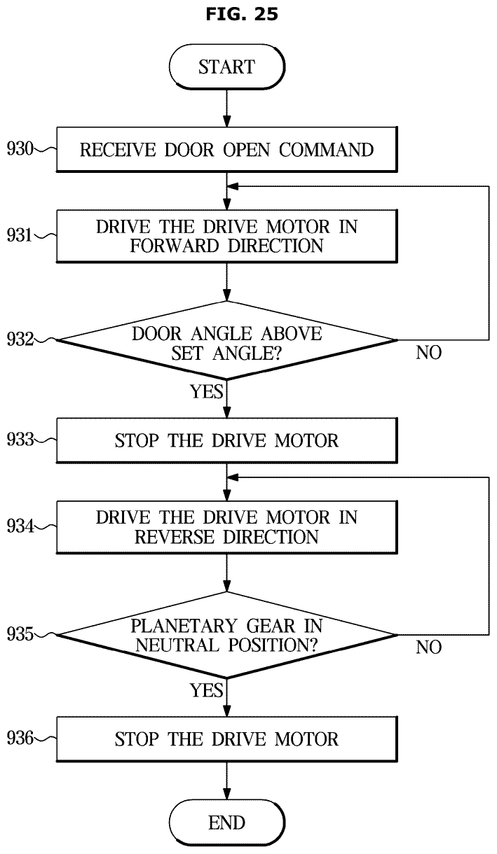

FIG. 25 is a view illustrating a control flow when an open command is received according to an embodiment of the present disclosure.

The door open command may be received from the input interface 610 (930).

The controller 700 may drive the drive motor 210 in the forward direction until the controller 700 recognizes that the door has been opened to a set angle based on the door open command being received through the input interface 610 (931, 932).

Specifically, the controller 700 may recognize that the door has been opened to the set angle based on the opening angle of the door detected by the angle sensor 810 reaching the set angle.

Alternatively, the controller 700 may recognize that the door has been opened to the set angle based on a drive motor FG count value reaching a set FG count value after forward driving of the drive motor 210 is initiated.

Alternatively, the controller 700 may recognize that the door has been opened to the set angle based on a set time elapsing after forward driving of the drive motor 210 begins. Alternatively, the controller 700 may recognize that the door has been opened to the set angle based on the drive motor FG count value reaching the set FG count value after detecting that the planetary gear 510 has reached the open position 510(O) by the open position sensor 840.

Alternatively, the controller 700 may recognize that the door has been opened to the set angle based on the set time elapsing after detecting that the planetary gear 510 has reached the open position 510(O) by the open position sensor 840.

The controller 700 may stop the drive motor 210 for the set time based on recognizing that the door has been opened to the set angle (933).

During the period of time that the drive motor 210 is stopped for the set time, the push rod 330 may be restored rearwardly (B) by the elastic force of the elastic member 370. While the push rod 330 is being restored rearwardly (B) by the elastic force of the elastic member 370, the push rod 330 is in a state of being meshed with the opening gear 320, so the speed of the return motion of the push rod 330 may be reduced. In addition, noise generated by the rapid return and collision of the push rod 330 may be reduced.

The controller 700 may drive the drive motor 210 in the reverse direction until the controller 700 recognizes that the planetary gear 510 has reached the neutral position 510(N) based on the set time elapsing after recognizing that the door has been opened to the set angle (934, 935).

Specifically, the controller 700 may recognize that the planetary gear 510 has reached the neutral position 510(N) based on the drive motor FG count value reaching the set FG count value after reverse driving of the drive motor 210 has started.

Alternatively, the controller 700 may recognize that the planetary gear 510 has reached the neutral position 510(N) based on the set time elapsing after reverse driving of the drive motor 210 is initiated.

Alternatively, the controller 700 may recognize that the planetary gear 510 has reached the neutral position 510(N) based on detecting that the planetary gear 510 has reached the neutral position 510(N) by the position sensors 840 and 850.

The controller 700 may stop the drive motor 210 based on recognizing that the planetary gear 510 has reached the neutral position 510(N) (936).

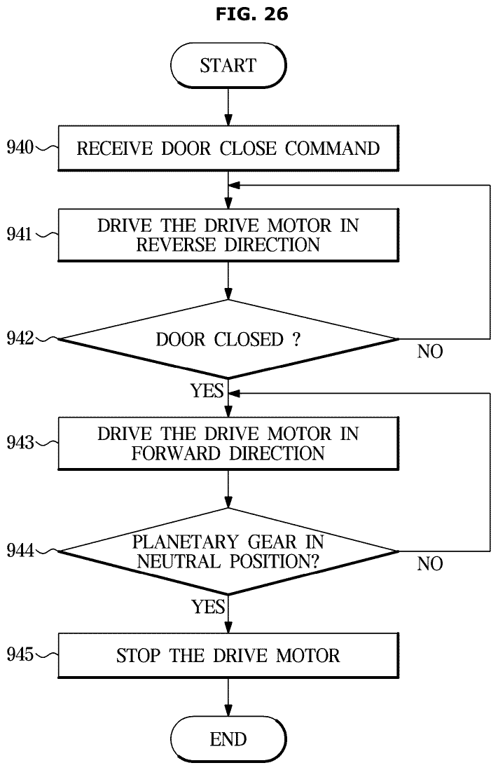

FIG. 26 is a view illustrating a control flow when a close command is received according to an embodiment of the present disclosure.

The door close command may be received from the input interface 610 (940).

The controller 700 may drive the drive motor 210 in the reverse direction until the controller 700 recognizes that the door has been closed based on the door close command being received through the input interface 610 (941, 942).

Specifically, the controller 700 may recognize that the door has been closed based on the opening angle of the door detected by the angle sensor 810 reaching 0 degrees.

Alternatively, the controller 700 may recognize that the door has been closed based on detecting that the door has been closed by the open/close sensor 820.

The controller 700 may drive the drive motor 210 in the forward direction until the controller 700 recognizes that the planetary gear 510 has reached the neutral position 510(N) based on recognizing that the door has been closed (943, 944).

Specifically, the controller 700 may recognize that the planetary gear 510 has reached the neutral position 510(N) based on the drive motor FG count value reaching the set FG count value after forward driving of the drive motor 210 is initiated.

Alternatively, the controller 700 may recognize that the planetary gear 510 has reached the neutral position 510(N) based on the set time elapsing after forward driving of the drive motor 210 begins.

Alternatively, the controller 700 may recognize that the planetary gear 510 has reached the neutral position 510(N) based on detecting that the planetary gear 510 has reached the neutral position 510(N) by the position sensors 840 and 850.

The controller 700 may stop the drive motor 210 based on recognizing that the planetary gear 510 has reached the neutral position 510(N) (945).

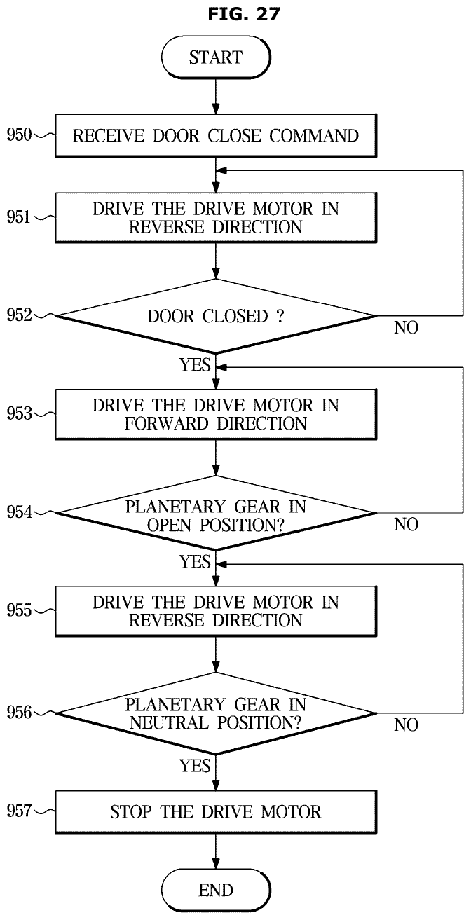

FIG. 27 is a view illustrating a control flow when a close command is received according to an embodiment of the present disclosure.

The door close command may be received from the input interface 610 (950).

The controller 700 may drive the drive motor 210 in the reverse direction until the controller 700 recognizes that the door has been closed based on the door close command being received through the input interface 610 (951, 952).

Specifically, the controller 700 may recognize that the door has been closed based on the opening angle of the door detected by the angle sensor 810 reaching 0 degrees.

Alternatively, the controller 700 may recognize that the door has been closed based on detecting that the door has been closed by the open/close sensor 820.

The controller 700 may drive the drive motor 210 in the forward direction until the controller 700 recognizes that the planetary gear 510 has reached the open position 510(O) based on recognizing that the door has been closed (953, 954).

Specifically, the controller 700 may recognize that the planetary gear 510 has reached the open position 510(O) based on the drive motor FG count value reaching the set FG count value after forward driving of the drive motor 210 is initiated.

Alternatively, the controller 700 may recognize that the planetary gear 510 has reached the open position 510(O) based on the set time elapsing after forward driving of the drive motor 210 begins.

Alternatively, the controller 700 may recognize that the planetary gear 510 has reached the open position 510(O) based on detecting that the planetary gear 510 has reached the open position 510(O) by the open position sensor 840.

The controller 700 may drive the drive motor 210 in the reverse direction until the controller 700 recognizes that the planetary gear 510 has reached the neutral position 510(N) based on recognizing that the planetary gear 510 has reached the open position 510(O) (955, 956).

Specifically, the controller 700 may recognize that the planetary gear 510 has reached the neutral position 510(N) based on the drive motor FG count value reaching the set FG count value after reverse driving of the drive motor 210 is initiated.

Alternatively, the controller 700 may recognize that the planetary gear 510 has reached the neutral position 510(N) based on the set time elapsing after reverse driving of the drive motor 210 begins.

Alternatively, the controller 700 may recognize that the planetary gear 510 has reached the neutral position 510(N) based on detecting that the planetary gear 510 has reached the neutral position 510(N) by the position sensors 840 and 850.

The controller 700 may stop the drive motor 210 based on recognizing that the planetary gear 510 has reached the neutral position 510(N) (957).

As described above, according to an embodiment of the present disclosure, the door opening/closing device 100 may perform both the door opening operation and the door closing operation using a single drive motor 210. Consequently, manufacturing costs and energy consumption may be reduced. Furthermore, the structure of the door opening/closing device may be simplified.

The door opening/closing device 100 according to an embodiment of the present disclosure may use the push structure that may press the door when opening the door and use the link structure that may pull the door when closing the door, so that the door opening operation and the door closing operation may be performed efficiently and smoothly.

According to the door opening/closing device 100 of an embodiment of the present disclosure, not only may the door be automatically opened/closed through the door opening/closing device 100, but it is also possible for a user to manually open/close the door.

In particular, after the door is automatically opened or closed by the door opening/closing device 100, the planetary gear 510 may be moved to the neutral position 510(N).

When the planetary gear 510 is in the neutral position 510(N), the planetary gear 510 may not be connected to the opening gear train and the closing gear train, so the door opening/closing device 100 may not act as a load during manual operation, and smooth manual operation may be possible.

Although the technical idea of the present disclosure is described with reference to a refrigerator, which is one of home appliances, as an object in the present disclosure, the present disclosure is not applied only to refrigerators among home appliances, and is equally applicable to other home appliances having a main body having a receiving space capable of receiving items for processing the items according to a specific purpose, such as a dishwasher or an oven, and a door provided to open/close the receiving space.

Although the above technical ideas of the disclosure have been described by way of specific embodiments, the scope of the disclosure is not limited to these embodiments. Various modifications and variations that can be made by those skilled in the art without departing from the technical ideas of the disclosure as set forth in the claims of the patent will be deemed to be within the scope of the disclosure.

1. A home appliance, comprising:
a main body having a receiving space;
a door configured to open or close to respectively open or close the receiving space; and
a door opening/closing device to be provided on the main body so that while the door opening/closing device is provided on the main body, the door opening/closing device is configured to open or close the door;
wherein the door opening/closing device includes:
a push portion including a push rod configured to push the door so as to open the door and an opening gear train to be connected to the push rod to move the push rod,
a linkage portion including a link connected to the door and configured so as to close the door and a closing gear train connected to the link and configured to move the link,
a drive portion including a drive motor and a sun gear connected to the drive motor, the drive motor configured to generate a driving force to rotate the sun gear, and
a clutch portion including a planetary gear, the planetary gear connected to the sun gear, configured to rotate with the sun gear, and movable between an open position where the planetary gear is connected to the opening gear train and a closed position where the planetary gear is connected to the closing gear train, so as to transmit the driving force of the drive motor to the push portion based on the planetary gear being in the open position or the linkage portion based on the planetary gear being in the closed position.

2. The home appliance of claim 1, further comprising:
an input interface configured to receive an open command and a close command, and
a controller configured to control the drive motor to open the door based on the open command being received through the input interface, and control the drive motor to close the door based on the close command being received through the input interface.

3. The home appliance of claim 2, wherein the controller is configured to:
based on the open command being received through the input interface, drive the drive motor in a forward direction until the controller recognizes that the door has been opened to a set angle and
based on recognizing that the door has been opened to the set angle, drive the drive motor in a reverse direction until the controller recognizes that the planetary gear has reached a neutral position.

4. The home appliance of claim 2, wherein the controller is configured to:
based on the close command being received through the input interface, drive the drive motor in a reverse direction until the controller recognizes that the door has been closed and
based on recognizing that the door has been closed, drive the drive motor in a forward direction until the controller recognizes that the planetary gear has reached a neutral position.

5. The home appliance of claim 1, wherein the planetary gear is configured to be meshed with the sun gear.

6. The home appliance of claim 1, wherein, based on the planetary gear being positioned between the open position and the closed position, the planetary gear is capable of revolving around the sun gear between the open position and the closed position with rotation of the sun gear.

7. The home appliance of claim 1, wherein,
based on the planetary gear being in the open position, the planetary gear is capable of rotating on its axis with rotation of the sun gear, and an opening gear of the opening gear train is configured to rotate with the rotation of the planetary gear on its axis, and
based on the planetary gear being in the closed position, the planetary gear is capable of rotating on its axis with rotation of the sun gear, and a closing gear of the closing gear train is configured to rotate with the rotation of the planetary gear on its axis.

8. The home appliance of claim 1, wherein the drive portion includes a sun gear pin inserted through a central portion of the sun gear to guide rotation of the sun gear.

9. The home appliance of claim 8, wherein
the clutch portion includes a carrier plate rotatable about the sun gear pin, and
the planetary gear is mounted on the carrier plate.

10. The home appliance of claim 9, wherein the clutch portion includes a friction member configured to generate a frictional force between the planetary gear and the carrier plate to allow the planetary gear to revolve around the sun gear with the rotation of the sun gear.

11. The home appliance of claim 9, wherein the clutch portion includes a planetary gear pin fixed to the carrier plate and inserted through a central portion of the planetary gear to guide rotation of the planetary gear on its axis.

12. The home appliance of claim 1, wherein the push rod is capable of linear movement between a maximum advanced position and a maximum retracted position.

13. The home appliance of claim 12, wherein the push portion includes an elastic member configured to elastically bias the push rod to the maximum retracted position.

14. The home appliance of claim 11, further comprising:
a hinge connecting the main body and the door and configured to rotatably support the door relative to the main body,
a cam coupled to the hinge and having a guide surface, and
a lever device coupled to the door and having a lever configured to contact the cam when the door is opened or closed.

15. The home appliance of claim 14, wherein:
the guide surface includes a first contact surface configured to allow the lever to apply a force in a direction configured to close the door when the lever is contacted, a second contact surface configured to allow the lever to transmit a force in a direction configured to open the door when the lever is contacted, and a inflection point between the first contact surface and the second contact surface; and
the lever contacts the second contact surface past the inflection point when the push rod is in a maximum advanced position.
